(19) United States
(12) Patent Application Publication
(10) Pub. No.: US 2026/0146212 A1
(43) Pub. Date: May 28, 2026

(54) MILD AND SELF-PRESERVED CONCENTRATED LIQUID DETERGENTS WITH BUFFER AND HIGH WATER CONTENT

(71) Applicant: Henkel AG & Co. KGaA, Duesseldorf (DE)

(72) Inventors: Daniel Thomas Piorkowski, Fairfield, CT (US); Gregory A. Cole, Stamford, CT (US); Brian Alan Warren, Louisville, KY (US)

(73) Assignee: Henkel AG & Co. KGaA, Duesseldorf (DE)

(21) Appl. No.: 19/383,061

(22) Filed: Nov. 7, 2025

Related U.S. Application Data
(60) Provisional application No. 63/724,650, filed on Nov. 25, 2024.

(51) Int. Cl. C11D 1/831; C11D 1/14; C11D 1/22; C11D 1/72; C11D 3/04; C11D 3/10; C11D 3/20

(52) U.S. Cl. CPC C11D 1/831; C11D 3/044; C11D 3/10; C11D 3/201; C11D 3/2065; C11D 1/146; C11D 1/22; C11D 1/72

(57) ABSTRACT

A self-preserved mild liquid detergent composition useful for laundry applications is disclosed. The liquid detergent composition contains the following components: glycerin, which is present in the detergent composition at less than 30 wt % based on the total weight of the liquid detergent composition; at least one anionic surfactant; at least one non-ionic surfactant; ethanol in an amount of 0.1-4 wt % based on the total weight of the liquid detergent composition; at least one buffer; and water in an amount effective to provide a water activity (wₐ) above 0.8 and up to 0.95 (0.8<a_{w}≤0.95), thus enabling it to be self-preserved. Significantly, the liquid detergent composition does not contain a preservative.

### CROSS REFERENCE TO RELATED APPLICATION

The present invention claims the benefit of U.S. Provisional Patent Application No. 63/724,650 filed Nov. 25, 2024, the entire content and disclosure of which is incorporated herein by reference.

### FIELD

The disclosure is directed to a self-preserved liquid detergent composition that does not contain preservatives. The liquid detergent also contains a buffer and higher water content than the conventional.

### BACKGROUND

Mildness, which relates to the reduction of skin irritation, is a significant consumer need and driver for laundry detergent purchase. Current commercially available laundry detergents include formulations free of dyes and perfumes, which can cause skin irritation. Other causes of skin irritation in laundry detergents include certain surfactants, preservatives, and stabilizers such as propylene glycol (PG). A variety of test methods as described, for example, in U.S. Published Patent Application No. 2018/0016523 are used to evaluate skin irritancy in laundry detergent use settings. Such methods include the Zein test as known in the art, which measures skin irritancy potential by determining the extent of denaturation of the Zien corn protein after exposure to a surfactant, as would be found in laundry detergents, for a given period of time. Another test to measure the skin irritancy is the corneosufametry (CSM) test as known in the art which is a non-invasive test quantitative test that measures the interaction between surfactants and human stratum corneum. Still another method to assess skin irritancy is the cytokine test as known in the art, which measures the cytokine release of representative human skin models in response to a surfactant-containing formulation. The aggregate of such test scores can be used to determine the mildness of the laundry detergent for the consumer.

Typically present in laundry detergents are preservatives, such as isothiazolinones including such compounds as methylisothiazolinone (MIT), benzisothiazolinone (BIT) and chloromethylisothiazolinone (CIT), which are added to forestall proliferation of bacteria, yeast and/or mold that could otherwise attend the formulation. However, preservatives can be sensitizing and cause skin irritation. Included among common surfactants used in laundry detergents are linear alkylbenzene sulfonates (LAS). The LAS are a class of anionic surfactants that are known to be advantageously biodegradable, but they are not as mild a surfactant as desired. Also present in typical laundry detergents are preservatives, such as isothiazolinones including such compounds as methylisothiazolinone (MIT), benzisothiazolinone (BIT) and chloromethylisothiazolinone (CIT), which are added to forestall proliferation of bacteria, yeast and/or mold that could otherwise attend the formulation. However, preservatives can be sensitizing and cause skin irritation. Stabilizers are often also used in laundry detergents to keep the ingredients from separating. A commonly employed stabilizer is propylene glycol, which compound can cause skin irritation and allergic reactions.

There is thus a need for a detergent composition does not contain preservatives, is of improved mildness, is self-preserved, and preferably contains less LAS and less propylene glycol (PG), and even more preferably, contains no LAS and/or no PG. There would be a further benefit in such a detergent composition that could possess a relatively high water activity, such as at least 0.8, while still maintaining self-preservation in the absence of a preservative.

### SUMMARY

A self-preserved liquid detergent composition useful for laundry applications is provided. The self-preserved liquid detergent composition of the invention disclosure does not contain preservatives. In one embodiment, the liquid detergent composition comprises up to about 5 wt % LAS, or up to about 5 wt % PG, or both up about 5 wt % LAS and separately up to about 5 wt % PG. In another embodiment, the liquid detergent composition does not contain LAS and/or PG. This disclosure focuses on laundry detergent concentrates that do not contain a preservative and are 2 to 4 times more concentrated than the standard detergent (an exemplary one is 1.5 fluid ounces per dose). Preservation is being controlled by use of solvents, such as glycerin and ethanol.

The liquid detergent composition of the disclosure contains an amount of water sufficient to provide a water activity of above 0.8 and up to or below 0.95 (0.8<a_{w}≤0.95), at which available water level mold, yeast, and bacteria have reduced survival rates. In one embodiment, the detergent composition of the disclosure is a concentrated liquid detergent and is not a unit dose product wherein the detergent composition is encapsulated in a small container typically made of polyvinyl acetate (PVA) film. Preservatives which are absent from the self-preserved liquid detergent composition include those known in the art, such as, without limitation, isothiazolinones, including methylisothiazolinone, benzisothiazolinone, chloromethylisothiazolinone and the like. In one embodiment, the liquid detergent composition of the disclosure is a concentrate that is about 2 to about 4 times more concentrated than known standard detergents, e.g. those that are 1.5 fluid ounces per dose. In another embodiment, the liquid detergent composition of the disclosure is in the form of a unit dose.

In one embodiment, the liquid detergent composition comprises glycerin (present in the detergent composition at less than 30 wt % based on the total weight of the liquid detergent composition); at least one anionic surfactant; at least one non-ionic surfactant; ethanol in an amount of 0.1-4 wt % based on the total weight of the liquid detergent composition; at least one buffer; and water in an amount effective to provide a water activity of 0.8<a_{w}≤0.95, wherein the liquid detergent composition does not contain preservatives, is of improved mildness, is self-preserved, and preferably contains less LAS and less PG, and even more preferably, contains no LAS and/or no PG.

In another embodiment, the self-preserved liquid detergent composition consists essentially of glycerin (present in the detergent composition at less than 30 wt % based on the total weight of the liquid detergent composition); at least one anionic surfactant; at least one non-ionic surfactant; ethanol in an amount of 0.1-4 wt % based on the total weight of the liquid detergent composition; at least one buffer; and water in an amount effective to provide a water activity of 0.8<a_{w}≤0.95, wherein the liquid detergent composition does not contain preservatives, is of improved mildness, is self-preserved, and preferably contains less LAS and less PG, and even more preferably, contains no LAS and/or no PG.

In yet another embodiment, the liquid detergent composition consists of glycerin (present in the detergent composition at less than 30 wt % based on the total weight of the liquid detergent composition); at least one anionic surfactant; at least one non-ionic surfactant; ethanol in an amount of 0.1-4 wt % based on the total weight of the liquid detergent composition; at least one buffer; and water in an amount effective to provide a water activity of 0.8<a_{w}≤0.95, wherein the liquid detergent does not contain preservatives, is of improved mildness, is self-preserved, and preferably contains less LAS and less PG, and even more preferably, contains no LAS and/or no PG.

### DETAILED DESCRIPTION

The entire contents of U.S. Published Patent Application No. 2018/0016523 are incorporated herein by reference for any purpose.

The present disclosure will now be described in greater detail by referring to the following discussion. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) and includes endpoints and includes any amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

At the outset, it is understood that the liquid detergent compositions described herein are intended to be mild. Mildness is a significant consumer need and driver for laundry detergent purchase. A variety of methods for testing mildness are described in U.S. Application Pub. No. 2018/0016523, the contents of which are herein incorporated by reference. These tests include Zein, Corneosufametry, and Cytokine testing. The aggregate of these scores can be used to determine the mildness of the detergent for the consumer.

The self-preserved liquid detergent of the present disclosure can be used in non-unit or unit dose form and includes or exclusively contains glycerin (present in the detergent composition at less than 30 wt % based on the total weight of the liquid detergent composition); at least one anionic surfactant; at least one non-ionic surfactant; ethanol in an amount of 0.1-4 wt % based on the total weight of the liquid detergent composition; at least one buffer; and water in an amount effective to provide a water activity of 0.8<a_{w}≤0.95, wherein the liquid detergent composition does not contain a preservative. Preservatives which are absent from the self-preserved liquid detergent composition include those known in the art such as without limitation isothiazolinones, including methylisothiazolinone, benzisothiazolinone, chloromethylisothiazolinone and the like.

In one embodiment, the liquid detergent composition comprises up to about 5 wt % LAS; or up to about 5 wt % PG; or up about 5 wt % LAS and separately up to about 5 wt % PG, based on the total weight of the liquid detergent composition. In one practice, the liquid detergent composition comprises about 0.05 wt % to about 1 wt % LAS, including e.g. about 0.1 wt % LAS. In one practice, the liquid detergent composition contains no LAS. In one practice, the liquid detergent composition comprises about 0.05 wt % to about 1 wt % PG, including e.g. about 0.1 wt % PG. In one practice, the liquid detergent composition contains no PG. In one preferred practice, the liquid detergent composition contains no LAS and no PG.

Water activity is a known measure of the freely available water in a material and indicates the availability of the water for chemical, biochemical, and microbial reactions. Water activity is stated as an “a_{w}” value and is defined as the quotient of the concentration of water in the vapor phase in the airspace over the liquid detergent composition and the water concentration in the airspace over pure water at a specific temperature, e.g. 25° C.: a_{w}=p/p₀.

In one practice, the water in the concentrated liquid detergent composition can be derived from added water and water that accompanies a component that forms the raw material that is used in formulating the detergent composition. In the concentrated liquid detergent composition of the disclosure, water is present in an amount effective to provide a water activity above 0.8 and up to 0.95 (0.8<a_{w}≤0.95). In different embodiments, the water activity is precisely, about, or at least 0.82, 0.85, 0.88, 0.90, or 0.92, and up to 0.95, or a water activity within a range bounded by any two of the foregoing values, e.g., 0.82-0.95, 0.82-0.92, 0.82-0.9, 0.82-0.88, 0.85-0.95, 0.85-0.92, 0.85-0.9, 0.85-0.88, 0.88-0.95, 0.88-0.92, 0.88-0.9, 0.9-0.95, or 0.9-0.92.

In one practice, the total water amount present in the liquid detergent composition is up to about 50 or 45 weight percent; in another practice, water is present from about 5 weight percent to about 45 weight percent, alternatively from about 10 weight percent to about 40 weight percent, alternatively from about 20 weight percent to about to about 35 weight percent, alternatively from about 25 weight percent to about 35 weight percent, alternatively from about 30 weight percent to about 50 weight percent, alternatively from about 40 weight percent to about 45 or 50 weight percent, or alternatively from about 45 weight percent to about 50 weight percent, based on the total weight of the detergent composition.

Glycerin is present in the liquid detergent composition in an amount of less than 30 wt % based on the total weight of the liquid detergent composition. In different embodiments, glycerin is present in the liquid detergent composition in an amount of precisely or about, for example, 10, 15, 20, 25, 26, 27, 28, or 29 wt % or an amount within a range bounded by any two of the foregoing values, e.g., 10-29 wt %, 15-29 wt %, 20-29 wt %, 10-28 wt %, 15-28 wt %, 20-28 wt %, 10-27 wt %, 15-27 wt %, 20-27 wt %, 10-25 wt %, 15-25 wt %, 20-25 wt %, 10-20 wt %, or 15-20 wt %, based on the total weight of the liquid detergent composition.

The ratio of glycerin to water may be within a range of, for example, 4:1 to 1:4, 3:1 to 1:3, 3:1 to 1:2, 2:1 to 1:2, about 1.5:1, about 1.2:1 or about 1:1, or within a range of 1.5:1 to 1:1. In other embodiments, the weight ratio of glycerin to water may be in a range of, for example, 1:1 to 1:4, 1:1 to 1:3, or 1:1 to 1:2. In further embodiments, the weight ratio of glycerin to water is about 1:0.5, about 1:0.8, about 1:1, about 1:1.2, about 1:13, or about 1:1.5.

The self-preserved liquid detergent of the present disclosure also contains at least one anionic surfactant. The at least one anionic surfactant may be present in the detergent composition in an amount of, for example, up about 45 weight percent, including from about 5 weight percent to about 40 weight percent, and including from about 20 weight percent to about 35 weight percent, and including about 25 weight percent to about 30 weight percent. In the present disclosure, all weight percentages are based on the total weight of the detergent composition unless otherwise specified.

Non-limiting examples of anionic surfactants that can be employed in the present disclosure include sulfates and sulfonates, in particular, phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), or combinations thereof. In particular embodiments, the anionic surfactant is a linear alkyl sulfate surfactant, or more particularly, a linear alkyl ether sulfate, such as sodium laureth sulfate (SLES). In some embodiments, one or more of the foregoing anionic surfactants is/are excluded.

The self-preserved liquid detergent of the present disclosure also contains at least one nonionic surfactant. The at least one nonionic surfactant may be present in the detergent composition in an amount of, for example, up about 45 weight percent, including from about 5 weight percent to about 40 weight percent, and including from about 20 weight percent to about 35 weight percent, and including about 25 weight percent to about 30 weight percent. In the present disclosure, all weight percentages are based on the total weight of the detergent composition unless otherwise specified.

Non-limiting examples of nonionic surfactants that can be employed in the present disclosure include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA). In particular embodiments, the nonionic surfactant is an alcohol ethoxylate, such as fatty alcohol ethoxylate C₁₂₋₁₅ 7EO. In some embodiments, one or more of the foregoing nonionic surfactants is/are excluded.

Any one or more of the above-described anionic surfactants may be combined with any one or more of the above-described nonionic surfactants. For example, in particular embodiments, the anionic surfactant is or includes a linear alkyl (ether) sulfate and the non-ionic surfactant is or includes an alcohol ethoxylate.

In some embodiments, the liquid detergent composition further includes at least one cationic surfactant. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, or combinations thereof. In some embodiments, a cationic surfactant is excluded.

In some embodiments, the liquid detergent composition further includes at least one semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, or combinations thereof. In some embodiments, the detergent composition of the present disclosure can include at least one zwitterionic surfactant. Non-limiting examples of zwitterionic surfactants that can be employed include betaines such as alkyldimethylbetaines, sulfobetaines, or combinations thereof. In some embodiments, a semipolar or zwitterionic surfactant is excluded.

The self-preserved liquid detergent of the present disclosure also contains ethanol in an amount of 0.1-4 wt % based on the total weight of the liquid detergent composition. In different embodiments, the ethanol is present in an amount of precisely or about, for example, 0.1, 0.2, 0.5, 1, 1.5, 2, 2.5, 3, 3.5, or 4 wt %, or the ethanol is present in an amount within a range bounded by any two of the foregoing values, e.g., 0.5-4 wt %, 1-4 wt %, 1-3.5 wt %, 1-3 wt %, 1-2.5 wt %, 1.5-4 wt %, 1.5-3.5 wt %, 1.5-3 wt %, 1.5-2.5 wt %, 2-4 wt %, 2-3.5 wt %, 2-3 wt %, 2-2.5 wt %, 2.5-4 wt %, 2.5-3.5 wt %, 2.5-3 wt %, 3-4 wt %, or 3-3.5 wt %. In particular embodiments, the ethanol is present in an amount of about 1.5 wt %, or about 3 wt %, or within a range of about 1.5-3 wt % based on the total weight of the liquid detergent composition.

The self-preserved liquid detergent of the present disclosure also contains at least one buffer. The buffer is typically present in an amount of 0.1 wt % to 0.5 wt % (or more particularly, 0.1-0.4 wt %, 0.2-0.5 wt %, 0.2-0.4 wt %, or 0.2-0.3 wt %) based on the total weight of the liquid detergent composition. Non-limiting examples of buffers include carbonate buffers, amino acids (e.g., lysine), monoethanolamine, triethanolamine, boric acid, glucosamine, and glucose diamine. In particular embodiments, the buffer is a carbonate buffer. The carbonate buffer is typically an alkali carbonate compound, such as sodium carbonate.

In some embodiments, in addition to glycerin and ethanol, a non-aqueous solvent (NAS) can be used. For clarity, the terms “non-aqueous solvent” or “NAS” as used herein do not include glycerin or ethanol which, while being non-aqueous solvents, are considered separate components in the liquid detergent composition of the disclosure. In some embodiments, the NAS is present in the liquid detergent composition in an amount from up about 40 weight percent, including from about 5 weight percent to about 35 weight percent, and including from about 25 weight percent to about 30 weight percent. In other embodiments, non-aqueous solvents are excluded.

In some embodiments, the NAS may be chosen from polyethylene glycol (“PEG”); polypropylene glycol; polypropylene glycol esters; polyethylene glycol esters such as polyethylene glycol stearate, polyethylene glycol laurate, and/or polyethylene glycol palmitate; methyl ester ethoxylate; diethylene glycol; dipropylene glycol; sorbitol; tetramethylene glycol; butylene glycol; pentanediol; hexylene glycol; heptylene glycol; octylene glycol; 2-methyl-1,3-propanediol; xylitol; mannitol; erythritol; dulcitol; inositol; adonitol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with the non-aqueous solvent has a weight average molecular weight of 4000 Daltons or less. In some embodiments, the NAS is selected from polyethylene glycol; polyethylene glycol esters such as polyethylene glycol stearate, polyethylene glycol laurate, and/or polyethylene glycol palmitate; polypropylene glycol. Esters of any of the foregoing solvents may alternatively be used. In some embodiments, any one or more of the above types of solvents are excluded.

In some embodiments, the NAS is polyethylene glycol (PEG) or an ester thereof. The PEG can have a weight average molecular weight ranging, for example, from about 100 to about 4000 Daltons. Suitable PEGs can have a weight average molecular weight of, for example, about 300, about 400, about 500, about 600, about 700, about 800, about 900, about 1000, about 1100, about 1200, about 1300, about 1400, about 1500, about 1600, about 1700, about 1800, about 1900, about 2000, about 2100, about 2200, about 2300, about 2400, about 2500, or about 2600, about 2700, about 2800, about 2900, about 3000, about 3500, or about 4000 Daltons.

In some embodiments, the glycerin can be used in a blend with an NAS such as polyethylene glycol, e.g. PEG 400. In other embodiments, the NAS is PEG 400 in an amount up to about 40 weight percent, including from about 5 weight percent to about 35 weight percent, and including from about 25 weight percent to about 30 weight percent.

In some embodiments, the detergent composition of the present disclosure further includes at least one enzyme. The at least one other enzyme can enhance the cleaning performance (including, for example, stain removal, redeposition of soil released in the washing/cleaning process, or restoration, fully or partially, the whiteness of a textile) of other components that are present in the detergent composition of the present disclosure. Exemplary enzymes include, but are not limited to, a deoxyribonuclease (DNaese), cellulase, protease, lipase, cutinase, amylase, peroxidase, oxidase, mannanase, or combination of any two or more of these. If present, the enzyme(s) is typically present in an amount of up to about 5 weight percent, or more typically about 1 weight percent to about 3 weight percent. In other embodiments, an enzyme is excluded.

In addition to the above-mentioned components, the detergent composition of the present disclosure can include any additional detergent component(s) known in the art. Other optional detergent components include, for example, bleaching systems, anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, and wicking agents, either alone or in combination. Any component known in the art for use in detergents may or may not be included. The choice of such optional components and the working amounts is well within the skill of the artisan. In some embodiments, one or more of any of the above additional components is/are excluded.

In some embodiments, the detergent composition of the present disclosure can further include well known dye transfer agents, fluorescent whitening agents, soil release polymers, rheology modifiers or any combination thereof. In some embodiments, the detergent composition of the present disclosure can also include a fatty acid that has a formula R—C(O)OH, wherein R is a C₅-C₂₁ linear or branched aliphatic group. In one example, the fatty acid is dodecanoic acid (also known as coconut fatty acid). In other embodiments, one or more of the above optional components is/are excluded.

In some embodiments, the liquid detergent composition further includes at least one chelating agent (chelant). Non-limiting examples of chelating agents include trisodium dicarboxymethyl alaninate (MGDA), ethylenediaminetetraacetate (EDTA), diethylenetriaminepentaacetate (DTPA), sodium gluconate, phosphates, and citrate salts. In other embodiments, one or more of the above chelating agents is/are excluded.

The detergent composition of the present disclosure can be formulated utilizing techniques well known to those skilled in the art. The various components that provide the detergent composition of the present disclosure can be added together and mixed in any order. In some embodiments, one or more components are successively added to a vessel under continuous stirring. In other embodiments, all components are added together and mixed. The addition is typically performed at room temperature, e.g., from about 20° C. to about 30° C.

Typically, the self-preserved liquid detergent composition has a pH of at least about 9 or 9.5 to about 11 or 11.5. In some embodiments, one or more pH adjusting agents is/are included in the liquid detergent to keep the pH within proper range. The pH adjusting agent may be, for example, any of the inorganic pH adjusting agents known in the art, such as an alkali hydroxide, such as sodium hydroxide.

Examples have been set forth below for the purpose of further illustrating the present disclosure. The scope of the present disclosure is not limited to any of the examples set forth herein.

### Example 1

Concentrated self-preserved liquid detergent compositions according to the disclosure were prepared. The detergent compositions were prepared by mixing the components in the amounts listed in Tables 1 and 2 in a standard overhead mixer. In this Example 1, Formulas 1, 2, 3, 4, and 5 represent practices of the conventional or state of the art while Formulas 6, 7, and 8 represent the practice of the present disclosure. No LAS, propylene glycol or any preservatives were used in the detergent compositions.

TABLE 1

| | | | | Formula 4 | Formula 5 |
|---|---|---|---|---|---|
| | Formula 1 | Formula 2 | Formula 3 | DTP5-83A | DR-01-122 |
| Formula | (Comparative) | (Comparative) | (Comparative) | (From Phase 1) | (Comparative) |
| Description | Carbonate | Carbonate | Carbonate | Carbonate | Control |
| pH | 10.2 | 10.2 | 10.2 | 10.29 | 10.92 |
| SG | N/A | N/A | N/A | 1.09 | 1.03 |
| Viscosity | N/A | N/A | N/A | 291 | 471 |
| Water | N/A | N/A | N/A | 0.72 | 0.98 |
| activity | | | | | |
| Dose (g) | 18.74 g | 18.74 g | 18.74 g | 18.74 g | 22.77 g |
| Dose (fl oz) | 0.58 | 0.58 | 0.58 | 0.58 | 0.75 |
| Concentration | 2.6x | 2.6x | 2.6x | 2.6x | 2x |
| (1x = 1.5 | | | | | |
| fl oz) | | | | | |
| Stability | Not Stable | Not Stable | Not Stable | Stable for | Stable for |
| | After Mixing | After Mixing | After Mixing | 1+ month | 1+ month |
| Description | Only Non- | Only Non- | SLES/Non- | SLES/Non- | Control |
| | ionic, No | ionic with | ionic Blend, | ionic Blend, | |
| | Ethanol | Ethanol | no Ethanol | with Ethanol | |

| Ingredient | Active Level | wt % | wt % | wt % | wt % | wt % |
|---|---|---|---|---|---|---|
| Glycerin | 100 | 33.04 | 32.14 | 32.38 | 30.88 | 0 |
| Alcohol | 100 | 36.66 | 36.66 | 31.76 | 31.76 | 13.92 |
| Ethoxylate | | | | | | |
| 25-7 | | | | | | |
| SLES | 70 | 0 | 0 | 7 | 7 | 9.94 |
| 20% Na- | 20 | 1 | 1 | 1 | 1 | 2.5 |
| Carbonate | | | | | | |
| Solution | | | | | | |
| Water | 100 | 26.1 | 25.5 | 24.66 | 24.66 | 65.98 |
| Fatty Acid | 100 | 1 | 1 | 1 | 1 | 0.28 |
| 200 Proof | 100 | 0 | 1.5 | 0 | 1.5 | 1.5 |
| Ethanol | | | | | | |
| MGDA | 40 | 1.94 | 1.94 | 1.94 | 1.94 | 4 |
| Chelant | | | | | | |
| NaOH | 50 | 0.26 | 0.26 | 0.26 | 0.26 | 0 |
| Performance | 78.7 | 0 | 0 | 0 | 0 | 1.73 |
| Polymer, | | | | | | |
| Anti- | | | | | | |
| redeposition | | | | | | |
| Polymer | | | | | | |
| Preservative | 20 | 0 | 0 | 0 | 0 | 0.15 |
| Total | | 100 | 100 | 100 | 100 | 100 |

TABLE 2

| | Formula 6 | Formula 7 | Formula 8 |
|---|---|---|---|
| | DTP5-83Z | DTP5-102A | DTP5-102D |
| Formula | (Inventive) | (Inventive) | (Inventive) |
| Description | Carbonate | Carbonate | Carbonate |
| pH | 10.2 | 10.2 | 10.2 |
| SG | N/A | N/A | N/A |
| Viscosity | N/A | N/A | N/A |
| Water activity | 0.90 | 0.73 | 0.92 |
| Dose (g) | 18.74 g | 18.74 g | 18.74 g |
| Dose (fl oz) | 0.58 | 0.58 | 0.58 |
| Concentration | 2.6x | 2.6x | 2.6x |
| (1x = 1.5 fl oz) | | | |
| Stability | Stable for | Stable for | Stable for |
| | 1+ month | 1+ month | 1+ month |
| Description | Higher Water | Lower Water | Higher Water |
| | Activity, 1.5% | Activity, 3% | Activity, 3% |
| | Ethanol | Ethanol | Ethanol |

| Ingredient | Active Level | wt % | wt % | wt % |
|---|---|---|---|---|
| Glycerin | 100 | 15 | 29.4 | 10 |
| Alcohol | 100 | 31.76 | 31.76 | 31.76 |
| Ethoxylate | | | | |
| 25-7 | | | | |
| SLES | 70 | 7 | 0 | 7 |
| 20% Na- | 20 | 1 | 1 | 1 |
| Carbonate | | | | |
| Solution | | | | |
| Water | 100 | Balance (~40.54) | Balance (~24.66) | Balance (~44) |
| Fatty Acid | 100 | 1 | 1 | 1 |
| 200 Proof | 100 | 1.5 | 3 | 3 |
| Ethanol | | | | |
| MGDA | 40 | 1.94 | 1.94 | 1.94 |
| NaOH | 50 | 0.26 | 0.26 | 0.26 |
| Polymers | N/A | 0 | 0 | 0 |
| and | | | | |
| Preservative | | | | |
| Total | | 100 | 100 | 100 |

The following additional blends were created with the above formulas, and shown below in Tables 3A and 3B with the indicated ratios. This was done in case there was a specific water activity level that was crucial for a micro challenge pass. The blends were created with the low and high water activity formulas with either 1.5% or 3% ethanol.

TABLE 3A

| | DTP5-83A | DTP5-83Z | | Water |
|---|---|---|---|---|
| | (Formula 4) | (Formula 6) | Total | Activity |
| DTP5-83E | 90 | 10 | 100 | 0.79 |
| DTP5-83F | 80 | 20 | 100 | 0.79 |
| DTP5-83G | 70 | 30 | 100 | 0.81 |
| DTP5-83H | 60 | 40 | 100 | 0.81 |
| DTP5-83I | 50 | 50 | 100 | 0.84 |
| DTP5-83J | 40 | 60 | 100 | 0.85 |
| DTP5-83K | 30 | 70 | 100 | 0.86 |
| DTP5-83L | 20 | 80 | 100 | 0.87 |
| DTP5-83M | 10 | 90 | 100 | 0.88 |

TABLE 3B

| | DTP5-102A | DTP5-102D | | Water |
|---|---|---|---|---|
| | (Formula 7) | (Formula 8) | Total | Activity |
| DTP5-102E | 90 | 10 | 100 | 0.76 |
| DTP5-102F | 80 | 20 | 100 | 0.79 |
| DTP5-102G | 70 | 30 | 100 | 0.80 |
| DTP5-102H | 60 | 40 | 100 | 0.82 |
| DTP5-102I | 50 | 50 | 100 | 0.84 |
| DTP5-102J | 40 | 60 | 100 | 0.86 |
| DTP5-102K | 30 | 70 | 100 | 0.87 |
| DTP5-102L | 20 | 80 | 100 | 0.89 |
| DTP5-102M | 10 | 90 | 100 | 0.90 |

Micro challenges were then run on the samples above for log reduction rates of bacteria and fungi. Bacteria were double challenged (inoculated about 1×10⁸ to 1×10⁹ CFU/g) and fungi (inoculated about 1×10⁸ to 5×10⁸ CFU/g) were single challenged.

A. brasiliensis (mold), S. aureus, E. coli, P. gergoviae/B. cepacia mixture, P. aeruginosa, C. albicans, and H. venusta were tested.

Pass criteria for bacterium is greater than 3 log reduction on day 7 and 4 logs on day 28. Fungi is greater than 1 log reduction at 14 days with no growth observed afterwards. Generally, a 5 log reduction was required to reach the detection limit for each microbe.

As shown in Table 4 below, all samples passed the above micro challenge criteria (Formula 4, 6, 7, 8 and the blends outlined above (DTP-5-83 and DTP5-102 sample series):

TABLE 4

| | Bacteria | Yeast | Mold |
|---|---|---|---|
| DTP5-83 Series | At Day 7, reduction to | At least 1 log | At least 1 log |
| (1.5% Ethanol) | the detection limit | reduction at Day 14. | reduction at Day 14, |
| DTP5-83A, 83Z, | (less than 10 CFU/g) | At least 3 log | 21, 28 |
| 83E, 83F, 83G, 83H, | for gram negative (E. | reduction at Day 28 | At Day 28, reduction |
| 83I, 83J, 83K, 83L, | coli, P. gergoviae/B. | | to the detection limit |
| 83M | cepecia mixture, P. | | (less than 10 CFU/g) |
| | aeruginosa, H. | | |
| | venusta) and gram | | |
| | positive bacteria (S. | | |
| | aureus) | | |
| DTP5-102 Series | At Day 7, reduction to | At least 1 log | At least 1 log |
| (3% Ethanol) | the detection limit | reduction at Day 14. | reduction at Day 14, |
| DTP5-102A, 102D, | (less than 10 CFU/g) | At Day 20, reduction | 21. |
| 102E, 102F, 102G, | for gram negative (E. | to the detection limit | At Day 28, reduction |
| 102H, 102I, 102J, | coli, P. gergoviae/B. | (less than 10 CFU/g) | to the detection limit |
| 102,K, 102L, 102M | cepecia mixture, P. | | (less than 10 CFU/g) |
| | aeruginosa, H. | | |
| | venusta) and gram | | |
| | positive bacteria (S. | | |
| | aureus) | | |

As described in the table above, the pH, water activity, suggested dose, concentration and viscosity are included.

Formulas 1, 2 and 3 formed a clear phase separation after mixing. Both SLES (co-surfactant) and ethanol (co-solvent) were needed to maintain stability.

Formula 4 and inventive Formulas 6, 7, and 8 were stable after mixing and continued to be stable for 1 month (stability testing still in progress) at −20° F., 40° F., 75° F., 105° F. as well as 1 week at 125° F. Formula 5 had the same stability as Formula 4.

Further, it was found that Formula 4 was also stable with 1% ethanol added to the formula instead of 1.5%. This may be advantageous since it would increase the flash point of the product that is intended for e-commerce.

Ratios of non-ionic to SLES that can be considered include 12:1 to 2:1. A lower level of SLES is preferred from a mildness point-of-view since non-ionic surfactants are generally milder than anionic. However, a minimum amount of SLES and ethanol is beneficial to maintain product stability as shown in Formulas 1, 2 and 3. Non ethoxylated nonionic surfactants can also be included.

Further, Zein testing was performed with Formulas 4, 5, 6, 7, and 8 at a 10% dilution (standard for liquid detergents) and 3% (standard for unit dose detergents). The 3% dilution was performed since Formulas 4 and 6 had an approximate concentration to a unit dose detergent. All scores were below 2% Zein dissolved, indicating a mild formulation.

One method to test the skin irritancy potential of a surfactant composition is the Zein test. The Zein test determines the extent of denaturation of Zein corn protein after exposure to a surfactant for a given period of time. Generally, the higher the Zein score, the greater the skin irritation potential. Table 5 below shows Zein scores for select formulas.

TABLE 5

| Product | Dilution | Zein % |
|---|---|---|
| Control (Formula 5) | 10% | 1.69 |
| | 3% | 0.39 |
| Carbonate (Formula 4) | 10% | 2.16 |
| (2.6x) | 3% | 0.77 |
| DTP5-102D (3% Ethanol, Formula 8) | 3% | 0.46 |
| DTP5-83Z (1.5% Ethanol, Formula 6) | 3% | 0.44 |

Formulas 4, 6, and 8 were designed to deliver the same amount of surfactant as an all free clear liquid detergent base product per dose to the washing machine. Formula 5 does not deliver the same amount of active surfactant as the all free clear liquid detergent base product and utilizes higher levels of chelants (MGDA) and an ethoxylated polyethyleneimine polymer, wherein MGDA refers to methylglycine diacetic acid. It was observed that a reduced glycerin formula also improved the Zein score from approximately 0.77 to 0.46%.

Further, additional performance polymers such as anti-redeposition or cleaning performance polymers may (or may not) be added to Formula 4.

It is preferred to keep the formulation above pH 10, most preferred above pH 10.5 as a secondary barrier for gram negative bacteria.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A self-preserved liquid detergent composition comprising:
glycerin, which is present in the detergent composition at less than 30 wt % based on the total weight of the liquid detergent composition;
at least one anionic surfactant;
at least one non-ionic surfactant;
ethanol in an amount of 0.1-4 wt % based on the total weight of the liquid detergent composition;
at least one buffer; and
water in an amount effective to provide a water activity (wₐ) above 0.8 and up to 0.95 (0.8<a_{w}≤0.95), wherein the liquid detergent composition does not contain a preservative.

2. The self-preserved liquid detergent composition of claim 1, wherein the water activity is between 0.85 to 0.95.

3. The self-preserved liquid detergent composition of claim 1, wherein said anionic surfactant is a linear alkyl (ether) sulfate surfactant.

4. The self-preserved liquid detergent composition of claim 3, wherein the linear alkyl (ether) sulfate surfactant is sodium laureth sulfate (SLES).

5. The self-preserved liquid detergent composition of claim 1, wherein the water is present at 30 wt % to 50 wt % based on the total weight of the liquid detergent composition.

6. The self-preserved liquid detergent composition of claim 1, wherein the water is present at 40 wt % to 50 wt % based on the total weight of the liquid detergent composition.

7. The self-preserved liquid detergent composition of claim 1, wherein the glycerin is present in the detergent composition at 10 wt % to 25 wt % based on the total weight of the liquid detergent composition.

8. The self-preserved liquid detergent composition of claim 1, wherein the ratio of glycerin to water is present in a wt % ratio within a range of about 1.5:1 to about 1:1.

9. The self-preserved liquid detergent composition of claim 1, wherein the non-ionic surfactant comprises an alcohol ethoxylate, an alcohol propoxylate, a propoxylated fatty alcohol, an alkoxylated fatty acid alkyl ester, an alkylphenol ethoxylate, a nonylphenol ethoxylate, an alkylpolyglycoside, an alkoxylated amine, a fatty acid monoethanolamide, a fatty acid diethanolamide, an ethoxylated fatty acid monoethanolamide, a propoxylated fatty acid monoethanolamide, a polyhydroxyalkyl fatty acid amide, a N-acyl N-alkyl derivative of glucosamine, or combinations thereof.

10. The self-preserved liquid detergent composition of claim 1, wherein the non-ionic surfactant comprises an alcohol ethoxylate.

11. The self-preserved liquid detergent composition of claim 1, wherein the anionic surfactant is a linear alkyl (ether) sulfate and the non-ionic surfactant comprises an alcohol ethoxylate.

12. The self-preserved liquid detergent composition of claim 11, wherein the linear alkyl (ether) sulfate is sodium laureth sulfate.

13. The self-preserved liquid detergent composition of claim 1, wherein the buffer is selected from the group consisting of carbonate buffers, amino acids (e.g., lysine), monoethanolamine, triethanolamine, boric acid, glucosamine, and glucose diamine.

14. The self-preserved liquid detergent composition of claim 1, wherein the buffer comprises a carbonate buffer (e.g., sodium carbonate).

15. The self-preserved liquid detergent composition of claim 1, further comprising an inorganic pH adjusting agent.

16. The self-preserved liquid detergent composition of claim 15, wherein the inorganic pH adjusting agent comprises sodium hydroxide.

17. The self-preserved liquid detergent composition of claim 1, further comprising at least one enzyme selected from a deoxyribonuclease, a cellulase, a protease, a lipase, a cutinase, an amylase, a peroxidase, an oxidase, a mannanase, or combinations thereof.

18. The self-preserved liquid detergent composition of claim 1 wherein the self-preserved liquid detergent composition contains no linear alkylbenzene sulfonates and no propylene glycol.

19. The self-preserved liquid detergent composition of claim 1 wherein the ethanol is in an amount of about 1.5 wt %, or about 3 wt %, or within a range of about 1.5-3 wt % based on the total weight of the liquid detergent composition.

20. The self-preserved liquid detergent composition of claim 1 further comprising (a) up to about 5 wt % of a linear alkylbenzene sulfonate; or (b) up to about 5 wt % of propylene glycol; or (c) up to about 5 wt % of a linear alkylbenzene sulfonate, and separately up to about 5 wt % of propylene glycol, based on the total weight of the liquid detergent composition.
